(19) United States
(12) Patent Application Publication
(10) Pub. No.: US 2025/0216253 A1
(43) Pub. Date: Jul. 3, 2025

(54) IMAGE SENSOR AND CONTROL METHOD THEREOF

(71) Applicants: SOLIDVUE, INC., Gyeonggi-do (KR); RESEARCH & BUSINESS FOUNDATION SUNGKYUNKWAN UNIVERSITY, Gyeonggi-do (KR)

(72) Inventors: Ho Uk LEE, Gyeonggi-do (KR); Yong Sung CHO, Gyeonggi-do (KR); Jae Hyuk CHOI, Seoul (KR); Jun Hee CHO, Gyeonggi-do (KR)

(73) Assignees: SOLIDVUE, INC., Gyeonggi-do (KR); RESEARCH & BUSINESS FOUNDATION SUNGKYUNKWAN UNIVERSITY, Gyeonggi-do (KR)

(21) Appl. No.: 18/920,174

(22) Filed: Oct. 18, 2024

(30) Foreign Application Priority Data
Dec. 29, 2023 (KR) 10-2023-0197252

(51) Int. Cl. G01J 1/44

(52) U.S. Cl. CPC G01J 1/44; G01J 2001/442; G01J 2001/4466

(57) ABSTRACT

Provided are an image sensor and a control method thereof. The image sensor includes a digital detection unit configured to detect light based on a single photon avalanche diode (SPAD), an analog detection unit configured to detect light based on a pinned photodiode (PPD), and a connection unit configured to transfer a specific amount of electric charges to the analog detection unit in detection of the light by the digital detection unit, in which the analog detection unit is further configured to count a number of photons based on an amount of electric charges accumulated during a specific time.

### CROSS-REFERENCE TO RELATED APPLICATION

This application is based on and claims priority under 35 U.S.C. § 119 to Korean Patent Application No. 10-2023-0197252, filed on Dec. 29, 2023, in the Korean Intellectual Property Office, the disclosure of which is incorporated by reference herein in its entirety.

### BACKGROUND

### 1. Field

The disclosure relates to an image sensor and a control method thereof in which the number of photons incident onto a pixel may be counted.

### 2. Description of the Related Art

A light-receiving element for detecting light is used in a LiDAR sensor, an image sensor, etc. Light-receiving elements are classified into pinned photodiodes (PPD), single photon avalanche diodes (SPAD), etc., and convert input light into an electrical signal and output the electrical signal.

FIG. 1 illustrates an example of a conventional PPD-based image sensor. Referring to FIG. 1, a PPD-based image sensor 100 may include a PPD 110, a buffer 120, and an analog-to-digital converter (ADC) 130. Upon incidence of light onto the PPD 110 during a specific period, a specific amount of electric charges are accumulated and the buffer 120 delivers the accumulated electric charges. The ADC 130 converts the amount of received electric charges into a digital signal and outputs the digital signal. That is, the PPD-based image sensor 100 is a sort of analog counter. As the PPD 110 has a smaller size than the SPAD, the PPD-based image sensor 100 is implementable as a small size and is capable of operating with low power, but linearity between the amount of electric charges and the number of photons piled in the PPD 110 is low, resulting in a limitation in counting an accurate number of photons. Such PPD-based image sensors have been studied for a long time and stably provide a highly complete scheme and are capable of stably operating in mid-illuminance and high-illuminance situations. However, in a low-illuminance situation, it is difficult to secure a dynamic range (DR).

FIG. 2 illustrates an example of a conventional SPAD-based image sensor. Referring to FIG. 2, an SPAD-based image sensor 200 may include an SPAD 210 and a counter 230. Upon incidence of photons onto the SPAD 210, the photons may be converted into a digital signal through a digital logic circuit 220, and the counter 230 may count and output the number of photons based on the digital signal. That is, the SPAD-based image sensor 200 is a sort of digital counter. The SPAD-based image sensor 200 of FIG. 2 is resistant to noise and is capable of accurately identifying the number of photons, but has a larger area and higher power consumption than the PPD. The SPAD-based image sensor 200 has good sensitivity in low illuminance, but when photons are continuously input during a high-illuminance situation, the photons may not be counted due to deadtime, etc.

### SUMMARY

Provided are an image sensor and a control method thereof, the image sensor being implemented with hybrid pixels including both an SPAD and a PPD to obtain a high dynamic range (HDR) even in high illuminance and low illuminance conditions.

Additional aspects will be set forth in part in the description which follows and, in part, will be apparent from the description, or may be learned by practice of the presented embodiments of the disclosure.

According to an aspect of the disclosure, an image sensor includes a digital detection unit configured to detect light based on a single photon avalanche diode (SPAD), an analog detection unit configured to detect light based on a pinned photodiode (PPD), and a connection unit configured to transfer a specific amount of electric charges to the analog detection unit in detection of the light by the digital detection unit, in which the analog detection unit is further configured to count a number of photons based on an amount of electric charges accumulated during a specific time.

According to another aspect of the disclosure, a control method of an image sensor including a hybrid pixel including a single photon avalanche diode (SPAD) and a pinned photodiode (PPD) includes adjusting an electric potential of a first gate unit positioned between the SPAD and the PPD to isolate a specific amount of electric charges when electric charges are accumulated between the SPAD and the PPD upon incidence of photons to the SPAD, adjusting an electric potential of a second gate unit positioned between the PPD and the storage unit to transfer the specific amount of electric charges to the storage unit, and counting a number of photons based on electric charges above a specific level in the storage unit.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a conventional pinned photodiode (PPD)-based image sensor;

FIG. 2 illustrates an example of a conventional single photon avalanche diode (SPAD)-based image sensor;

FIG. 3 illustrates an example of a pixel structure of an image sensor according to an embodiment;

FIGS. 4 and 5 illustrate a potential diagram of a pixel according to an embodiment;

FIG. 6 illustrates an example of a control method of a pixel according to an embodiment;

FIGS. 7 to 13 show a change in a potential diagram according to control of FIG. 6;

FIG. 14 illustrates another example of a control method of a pixel according to an embodiment;

FIGS. 15 to 20 show a change in a potential diagram according to control of FIG. 14;

FIG. 21 illustrates an example of a control method of a charge accumulation (CA) mode of a pixel according to an embodiment;

FIG. 22 shows a change in a potential diagram according to control of FIG. 21;

FIGS. 23 to 26 show various examples of an operating mode of a pixel according to an embodiment;

FIG. 27 shows an example of a timing diagram of a pixel when both an analog photon counting (APC) mode and a CA mode of FIG. 26 are used;

FIG. 28 shows an example of an arrangement structure of an SPAD and a PPD in a pixel of an image sensor according to an embodiment; and

FIG. 29 shows another example of an image sensor according to an embodiment.

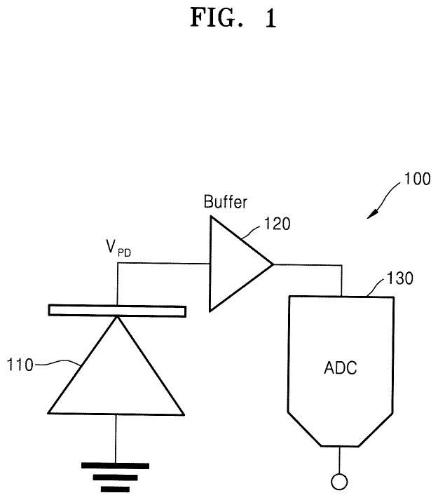

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, an image sensor and a control method thereof according to an embodiment will be described in detail with reference to the accompanying drawings.

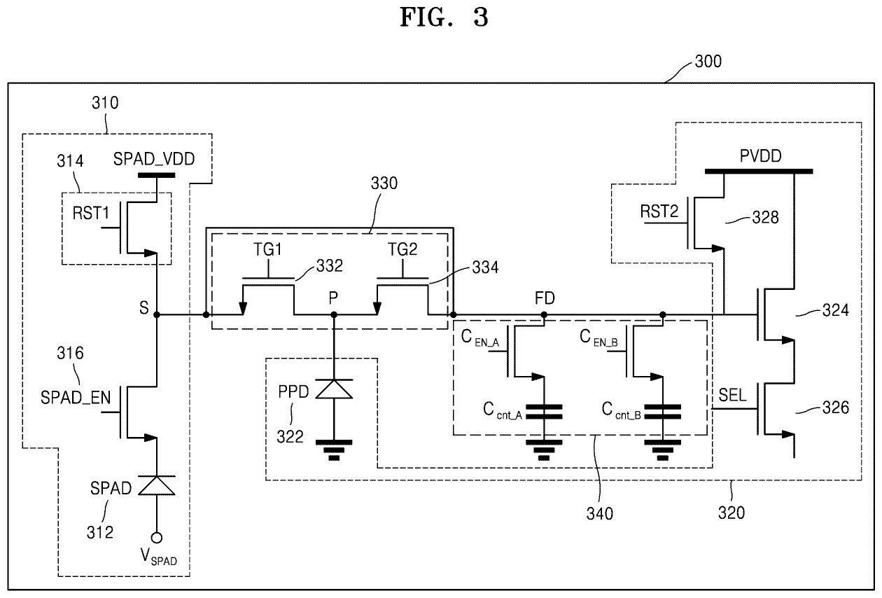

FIG. 3 illustrates an example of a pixel structure of an image sensor according to an embodiment.

Referring to FIG. 3, a pixel 300 may be implemented as a hybrid pixel including both a single photon avalanche diode (SPAD) 312 and a pinned photodiode (PPD) 322. For convenience of a description, the image sensor for one pixel is shown according to the current embodiment, but the image sensor may be implemented as a pixel array in which a plurality of pixels 300 are arranged. A structure and a control method of each pixel are the same, and thus a description will be made based on one pixel. The pixel 300 according to the current embodiment may be used in a LIDAR sensor or an image sensor for use in generation of an image frame.

The pixel 300 may roughly include a digital detection unit 310, an analog detection unit 320, a connection unit 330, and a storage unit 340. The storage unit 340 may be a component for expanding a full well capacity (FWC) and may be omitted depending on an embodiment. However, a case including the storage unit 240 will be described.

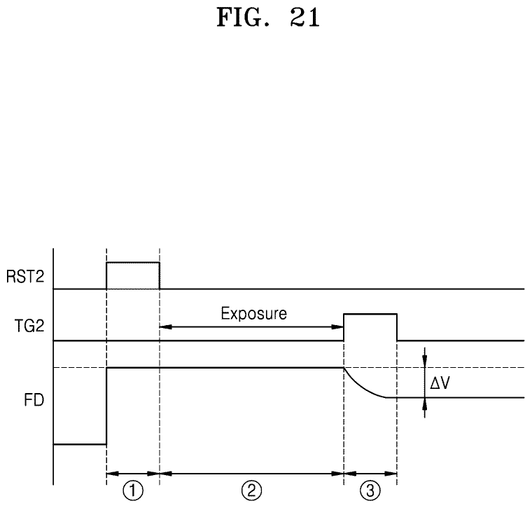

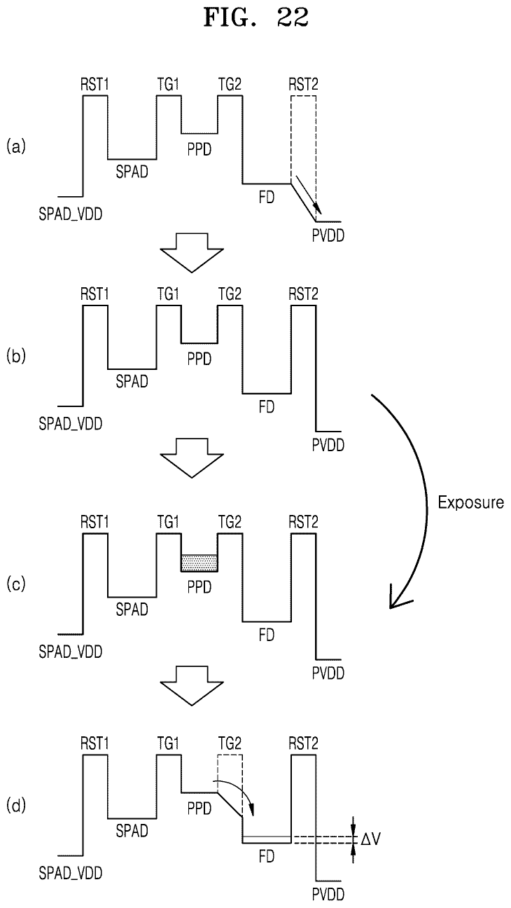

The digital detection unit 310 may detect light based on the SPAD 312. The digital detection unit 310 may include the SPAD 312, a first resetting unit 314, and a masking unit 316. The masking unit 316 may determine whether the SPAD 312 operates. For example, the masking unit 316 may be implemented with a metal oxide silicon field effect transistor (MOSFET) controlled by an SPAD_EN signal. That is, the image sensor may control the SPAD_EN signal of the masking signal 316 to determine whether the digital detection unit 310 operates. A method in which the pixel 300 operates with the analog detection unit 320 through control of the masking unit 310 will be described again with reference to FIGS. 21 and 22. The first resetting unit 314 may reset the digital detection unit 310. The first resetting unit 314 may be controlled by an RST1 signal of a MOSFET.

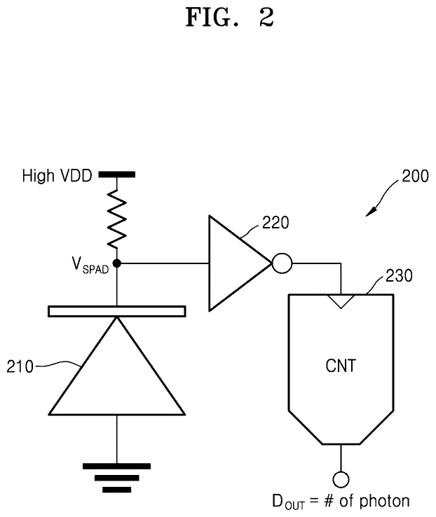

The analog detection unit 320 may detect light based on the PPD 322. The analog detection unit 320 may include the PPD 322, a pixel selection unit 326, an amplification unit 324, and a second resetting unit 328. The analog detection unit 320 may be a sort of analog counter that measures and outputs a certain amount of electric charges as shown in FIG. 2. Upon input of a selection signal with respect to a pixel into the selection unit 326, the analog detection unit 320 may output the amount of electric charges accumulated in the storage unit 340 through the amplification unit 324. The second resetting unit 328 may reset the analog detection unit 320 and the storage unit 340. The second resetting unit 328 may be controlled by an RST2 signal of the MOSFET.

The storage unit 340 may be implemented as a capacitor that stores electric charges. The storage unit 340 according to the current embodiment shows an example in which two capacitors are connected in parallel, but this is merely an example and various structures capable of implementing an FWC of the analog detection unit 340 may be applied to the current embodiment.

The connection unit 330 may connect the digital detection unit 310 to the analog detection unit 320. In an embodiment, the connection unit 330 may include a first gate unit 332 that adjusts a first gate potential between the digital detection unit 310 and the analog detection unit 320 and a second gate unit 334 that adjusts a second gate potential between the analog detection unit 320 and the storage unit 340. The connection unit 330 may transmit a specific amount of electric charges to the analog detection unit 320 and the storage unit 340 in light detection of the digital detection unit 310 by controlling the electric potential of the first gate unit 332 and the second gate unit 334.

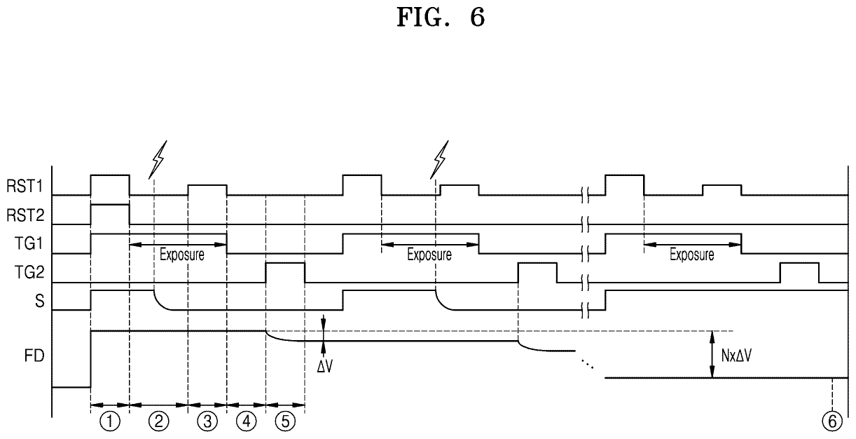

The pixel 300 may operate an analog photon counting (APC) mode and a charge accumulation (CA) mode based on the digital detection unit 310 and the analog detection unit 320. The APC mode is a mode in which the number of photons input to the SPAD 312 is counted through the analog detection unit 320. As the APC mode uses the SPAD 312, light may be detected well in low illuminance and the number of photons may be counted through the analog detection unit 320 including the PPD 322, such that a pixel may be implemented with a smaller size than the conventional SPAD-based image sensor 200 of FIG. 2. The CA mode is a mode in which the analog detection unit 320 operates without using the digital detection unit 310 to accumulate and count photons upon input of the photons to the PPD 322. An operation in the APC mode will be described with reference to FIGS. 6 to 20, and the CA mode will be described with reference to FIGS. 21 and 22.

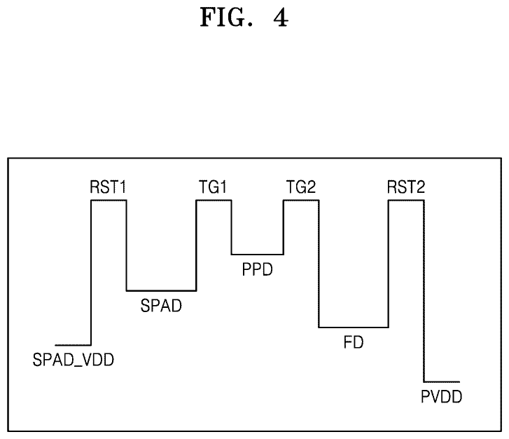

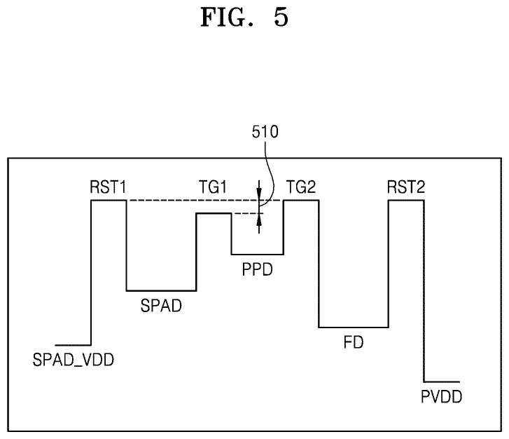

FIGS. 4 and 5 illustrate a potential diagram of a pixel according to an embodiment.

Referring to FIGS. 4 and 5, in an initial state before incidence of light onto the pixel 300, relative potentials of SPAD_VDD, the first resetting unit 314, the SPAD 312, the first gate unit 332, the PPD 322, the second gate unit 334, the storage unit 340, the second resetting unit 328, and the PVDD are shown. In a potential diagram according to the current embodiment, a voltage increases in a downward direction and decreases in an upward direction. For example, an electric potential of SPAD_VDD may be greater than an electric potential of the first resetting unit 314. However, hereinbelow, for convenience of a description, the vertical relationship of the potential diagram of FIGS. 4 and 5 will be expressed. That is, in FIGS. 4 and 5, the electric potential of SPAD_VDD is expressed as being less than the electric potential of the first resetting unit 314.

In an example of FIG. 4, an electric potential TG1 of the first gate unit 332 may be equal to an electric potential TG2 of the second gate unit 334. On the other hand, in an example of FIG. 5, the electric potential TG1 of the first gate unit 332 may be less than the electric potential TG2 of the second gate unit 334.

In FIG. 5, a potential difference 510 between the first gate unit 332 and the second gate unit 334 may occur according to a thickness of an overlapping section between a poly layer and a CPX layer that constitute the first gate unit 332. For example, when the thickness of the overlapping section between the poly layer and the CPX layer is 0.01 μm, the electric potentials of the first gate unit 332 and the second gate unit 334 may be equal to each other; when the thickness of the overlapping section between the poly layer and the CPX layer is very small as 0.005 μm, the electric potential of the first gate unit 332 may be different from the electric potential of the second gate unit 334.

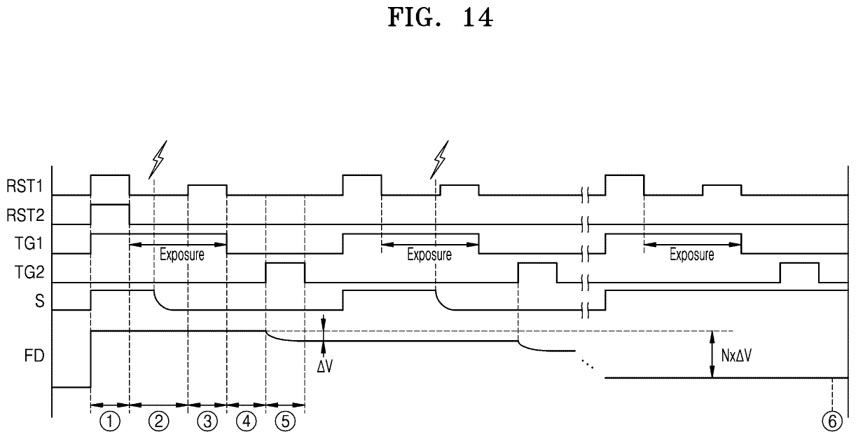

A control method of a pixel indicated by the potential diagram of FIG. 4 will be described with reference to FIGS. 6 to 13, and a control method of a pixel indicated by the potential diagram of FIG. 5 will be described with reference to FIGS. 14 to 20.

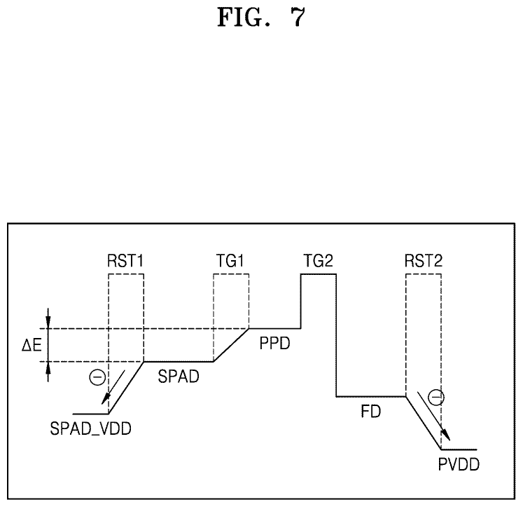

FIG. 6 illustrates an example of a control method of a pixel according to an embodiment, and FIGS. 7 to 13 show a change in a potential diagram according to control of FIG. 6.

Referring to FIG. 6, a control signal for adjusting an electric potential of each component of the potential diagram shown in FIG. 4 is shown. In the current embodiment, the first resetting unit 314, the second resetting unit 328, the first gate unit 332, and the second gate unit 334 have different potential levels in the potential diagram according to control signals.

Referring to FIG. 7, the image sensor may apply control signals to the first resetting unit 314, the second resetting unit 328, and the first gate unit 332 to reset the pixel 300 (\textcircled{1} of FIG. 6), thereby lowering the electric potentials of the first resetting unit 314, the second resetting unit 328, and the first gate unit 332 to discharge previously accumulated electric charges if any. After resetting the pixel 300, the image sensor may change the electric potentials of the first resetting unit 314 and the second resetting unit 328 into a state as shown in FIG. 4, and maintain the electric potential of the first gate unit 332 in a state at the time of resetting. After the resetting, a voltage at an output terminal S of the digital detection unit 310 may enter a high state.

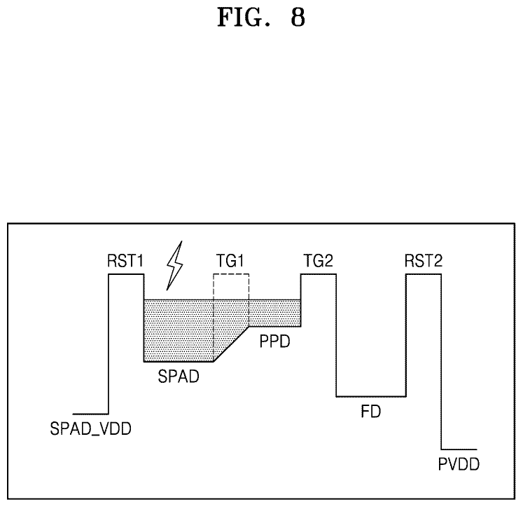

Referring to FIG. 8, upon incidence of the photons to the SPAD 312 after the resetting (\textcircled{2} of FIG. 6) (an SPAD avalanche & quenching state), the electric charges may be generated by the SPAD 312. The electric charges generated by the SPAD 312 may be accumulated between the first resetting unit 314 and the second gate unit 334, and the voltage at the output terminal S of the digital detection unit 310 may enter a low state.

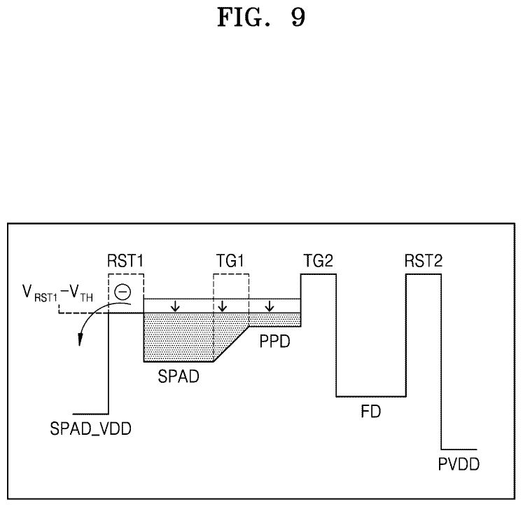

Referring to FIG. 9, the image sensor may adjust an electric potential level of the first resetting unit 314 to maintain the amount of electric charges accumulated between the first resetting unit 314 and the second gate unit 334 in the pixel 300 constant (\textcircled{3} of FIG. 6) (pixel-fixed pattern noise (FPN) reduction). For example, according to element physical properties (e.g., a quenching level, etc.) or operating environment of the SPAD 312, the amount of electric charges generated in the SPAD 312, etc., may not be the same at the time of incidence of the photons. In the current embodiment, as the number of photons may be counted based on the amount of electric charges accumulated above a certain level through the analog detection unit 320 described below, an error may occur in counting of the number of photons when the amount of electric charges accumulated changes each time. Thus, the image sensor may apply a second control signal lower than a first control signal for resetting to the first resetting unit 314 to reduce the electric potential of the first resetting unit 314 by a predefined height from the electric potential level of the initial state of FIG. 4 (that is, V_{RST1}-V_{TH}). A voltage V_{TH} for correcting an electric potential of the first resetting unit 314 may be predefined in advance for each pixel. When the electric potential level of the first resetting unit 314 decreases, some electric charges may be discharged through the digital detection unit 310, and a certain amount of electric charges may remain between the first resetting unit 314 and the second gate unit 334 each time. That is, each time when the photons are detected in the SPAD 312, the amount of electric charges accumulated between the first resetting unit 314 and the second gate unit 334 may be constant through a correction process of FIG. 9.

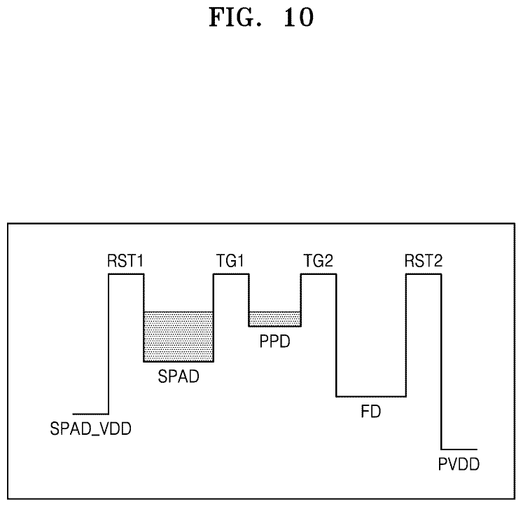

Referring to FIG. 10, the image sensor may control the first gate unit 332 in the pixel 300 to isolate some electric charges (\textcircled{4} of FIG. 6) (an isolation process). That is, the image sensor may increase the electric potential level of the first gate unit 332 to separate the SPAD 312 from the PPD 322. Thus, the electric charges between the first resetting unit 314 and the second gate unit 334 may be separated to the SPAD 312 and the PPD 322 by the first gate unit 334.

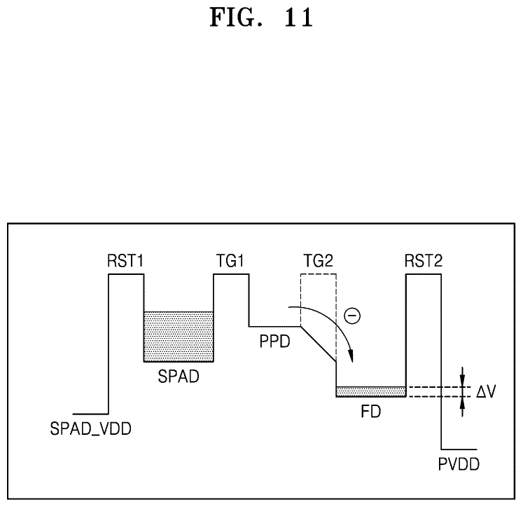

Referring to FIG. 11, the image sensor may control the second gate unit 334 in the pixel 300 to transfer the electric charges accumulated in the PPD 322 to the storage unit 340 (\textcircled{5} of FIG. 6) (charge transfer). That is, the image sensor may apply a control signal to the second gate unit 334 to reduce the electric potential level of the second gate unit 334 and transfer the electric charges accumulated in the PPD 322 to the storage unit 340, i.e., a counting capacitor. In other words, the image sensor may transfer the electric charges to an external capacitor of the storage unit 340 in the APC mode and transfer the electric charges to a parasitic capacitor of an FD node rather than the external capacitor in a CA mode.

The image sensor may repeat a process described with reference to FIGS. 7 to 11 for the pixel 300. In other words, after a process of FIG. 11 is performed, the pixel 300 may perform a resetting process of FIG. 6 and wait in a state of detecting the photons. When the photons are detected by the SPAD 312, the pixel 300 may accumulate a specific amount of electric charges in the storage unit 340 through a process of FIGS. 7 to 11.

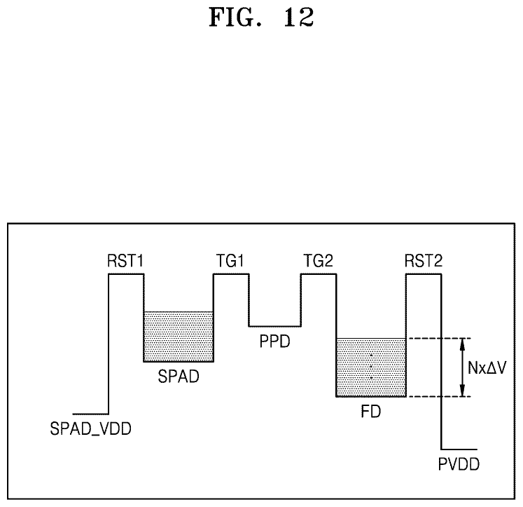

Referring to FIG. 12, the pixel 300 may repeat the process of FIGS. 7 to 11 and when electric charges above a specific level are accumulated in the storage unit 340, the pixel 300 may output the same (readout) (\textcircled{6} of FIG. 6). The image sensor may count the number of photons, Nₓ, by dividing the amount of electric charges accumulated in the storage unit 340, i.e., NₓΔV, by a unit electric charge amount ΔV accumulated once in photon detection. As the amount of electric charges accumulated in the storage unit 340 of the analog detection unit 320 is directly proportional to the number of photons, the pixel 300 may count the accurate number of photons.

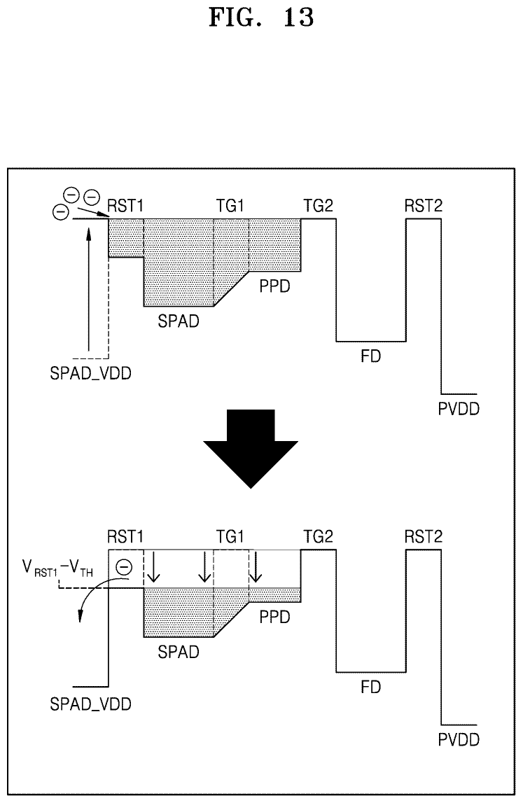

In another embodiment, an FPN of each pixel may not be completely removed through the correction process of FIG. 9. To this end, the image sensor may perform a post-correction process may be performed on the pixel 300 through a process of FIG. 13. In an embodiment, after a situation where the SPAD 312 may react may be created by increasing an exposure time of the pixel 300, the amount of electric charges generated by an FPN may be repeatedly accumulated N times through the process of FIGS. 7 to 11. In this way, the amount of electric charges by the FPN for each pixel may be identified. When the image sensor counts the number of photons in the pixel 300 through the process of FIG. 12, the image sensor may correct the amount of electric charges accumulated in the storage unit 340 to the amount of electric charges by the FPN and then count the number of photons.

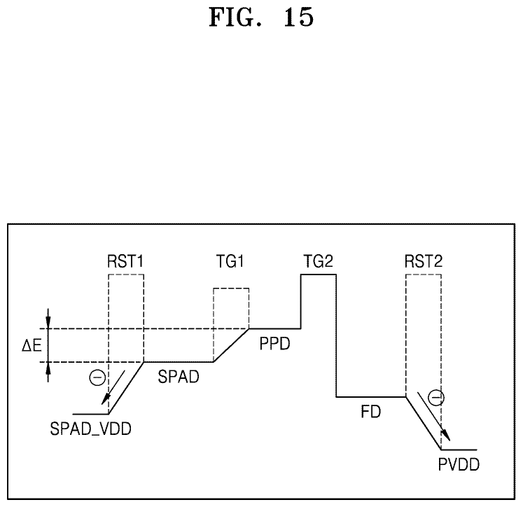

FIG. 14 illustrates another example of a control method of a pixel according to an embodiment, and FIGS. 15 to 20 show a change in a potential diagram according to control of FIG. 14.

Referring to FIG. 15, the image sensor may apply control signals to the first resetting unit 314, the second resetting unit 328, and the first gate unit 332 to reset the pixel 300 (\textcircled{1} of FIG. 14), thereby lowering the electric potential levels of the first resetting unit 314, the second resetting unit 328, and the first gate unit 332 to discharge previously accumulated electric charges if any. After resetting the pixel 300, the image sensor may change the electric potential levels of the first resetting unit 314 and the second resetting unit 328 into an initial state as shown in FIG. 5, and maintain the electric potential level of the first gate unit 332 in a state at the time of initialization. After the resetting, a voltage at an output terminal S of the digital detection unit 310 may enter the high state.

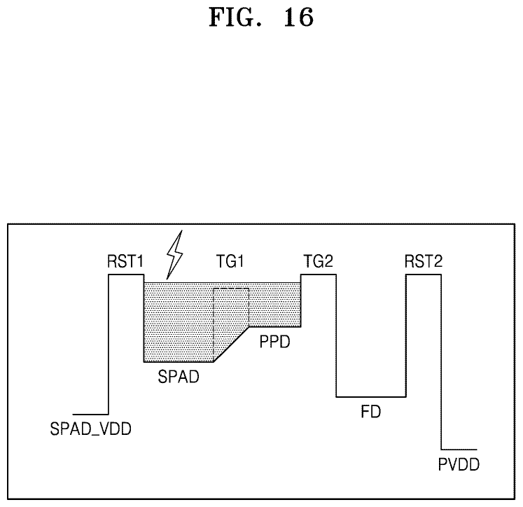

Referring to FIG. 16, upon incidence of the photons to the SPAD 312 after the resetting (\textcircled{2} of FIG. 14) (the SPAD avalanche & quenching state), the electric charges may be generated by the SPAD 312. The electric charges generated by the SPAD 312 may be accumulated between the first resetting unit 314 and the second gate unit 334, and the voltage at the output terminal S of the digital detection unit 310 may enter the low state.

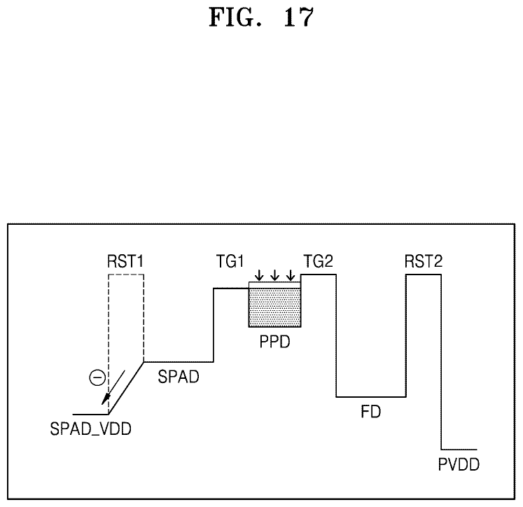

Referring to FIG. 17, the image sensor may control the first resetting unit 314 and the first gate unit 334 in the pixel 300 to isolate the electric charges (\textcircled{3} of FIG. 14) (the isolation process). That is, the image sensor may apply the control signal to the first resetting unit 314 to reduce the electric potential level of the first resetting unit 314 and to increase the electric potential level of the first gate unit 332 such that the electric charges may exist in the PPD 322. The control method of FIG. 6 may include a process of adjusting the electric potential level of the first resetting unit 314 by a predefined voltage V_{TH}) (the process of FIG. 9) to make the amount of electric charges accumulated in the PPD 322 constant, but in the current embodiment, as the electric potential level of the first gate unit 332 is lower than the electric potential level of the second gate unit 334 from the first, the amount of electric charges accumulated in the PPD 322 may be constant by merely controlling the first gate unit 332 without correcting the electric potential level of the first resetting unit 314.

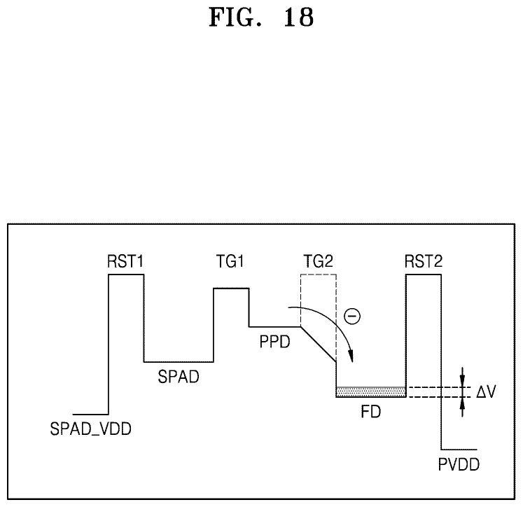

Referring to FIG. 18, the image sensor may control the second gate unit 334 in the pixel 300 to transfer the electric charges accumulated in the PPD 322 to the storage unit 340 (\textcircled{4} of FIG. 14) (charge transfer). That is, the image sensor may apply a control signal to the second gate unit 334 to reduce the electric potential level of the second gate unit 334 and transfer the electric charges accumulated in the PPD 322 to the storage unit 340.

The image sensor may repeat a process described with reference to FIGS. 15 to 18 for the pixel 300. In other words, after a process of FIG. 18 is performed, the pixel 300 may perform a resetting process of FIG. 15 and wait in a state of detecting the photons. When the photons are detected, the pixel 300 may accumulate a specific amount of electric charges in the storage unit 340 through a process of FIGS. 16 to 18.

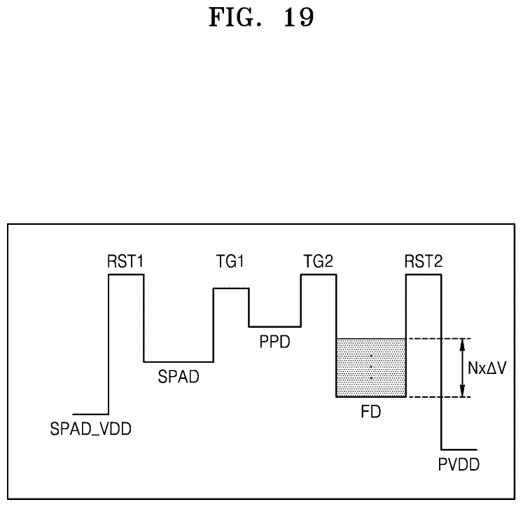

Referring to FIG. 19, the pixel 300 may repeat the process of FIGS. 15 to 18 and when electric charges above a specific level are accumulated in the storage unit 340, the pixel 300 may output the same (readout) (\textcircled{5} of FIG. 14). The image sensor may count the number of photons, Nₓ, by dividing the amount of electric charges accumulated in the storage unit 340, i.e., NₓΔV, by a unit electric charge amount ΔV accumulated once in photon detection. As the amount of electric charges accumulated in the storage unit 340 of the analog detection unit 320 is directly proportional to the number of photons, the pixel 300 may count the accurate number of photons.

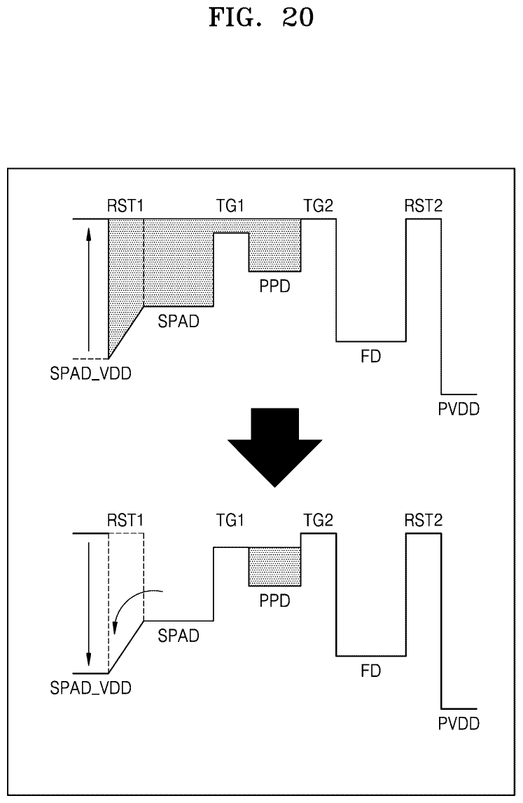

In the current embodiment, each pixel may not be affected by the electric potential of the first resetting unit 314, but the FPN may not be completely removed. To this end, the image sensor may perform a post-correction process through the process of FIG. 20. In an embodiment, after a situation where the SPAD 312 may react may be created by increasing an exposure time of the pixel 300, the amount of electric charges generated by an FPN may be repeatedly accumulated N times through the process of FIGS. 15 to 18. In this way, the amount of electric charges by the FPN for each pixel may be identified. When the image sensor counts the number of photons in the pixel 300 through the process of FIG. 19, the image sensor may correct the amount of electric charges of the storage unit 340 to the amount of electric charges by the FPN and then count the number of photons.

FIG. 21 illustrates an example of a control method of a CA mode of a pixel according to an embodiment. FIG. 22 shows a change in a potential diagram according to control of FIG. 21.

Referring to FIG. 21, the pixel 300 may perform a CA mode to stop operating the digital detection unit 310 and operate the analog detection unit 320. In an embodiment, the image sensor may stop operating the SPAD 312 through the masking unit 316 of the digital detection unit 310 in the pixel 300.

Referring to FIG. 22A, the image sensor may perform a resetting process of applying the control signal to the second resetting unit 328 in the pixel 300 to lower the electric potential level of the second resetting unit 328 and discharging the electric charges accumulated in advance if any (\textcircled{1} of FIG. 21).

Referring to FIG. 22B, the image sensor may increase electric potential level of the second resetting unit 314 after resetting the pixel 300 to wait in a state capable of detecting light (\textcircled{2} of FIG. 21). Referring to FIG. 22C, upon incidence of light onto the PPD 322, electric charges may be accumulated between the first gate unit 332 and the second gate unit 334 (\textcircled{2} of FIG. 21).

Referring to FIG. 22D, the image sensor may lower the electric potential level of the second gate unit 334 in the pixel 300 to transfer the electric charges accumulated in the PPD 322 to the storage unit 340, i.e., an FD (\textcircled{3} of FIG. 21).

The image sensor may perform a process of FIGS. 22B to 22D on the pixel 300 once. When the electric charges are accumulated in the storage unit 340 in the pixel 300 (ΔV), they may be transferred to the ADC through the amplification unit 324 and the corresponding amount of electric charges may be converted into a digital value.

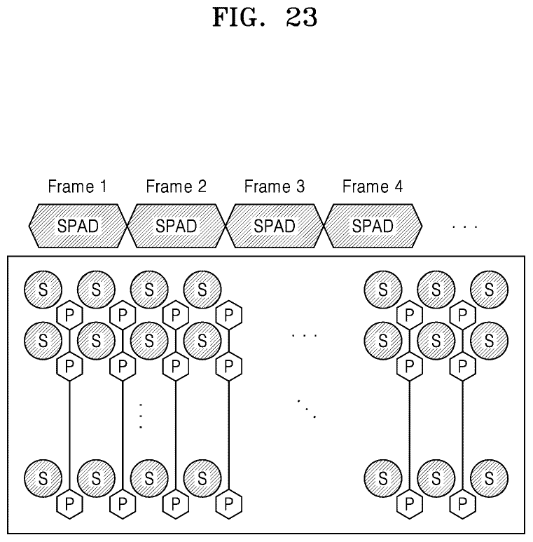

FIGS. 23 to 26 show various examples of an operating mode of a pixel according to an embodiment.

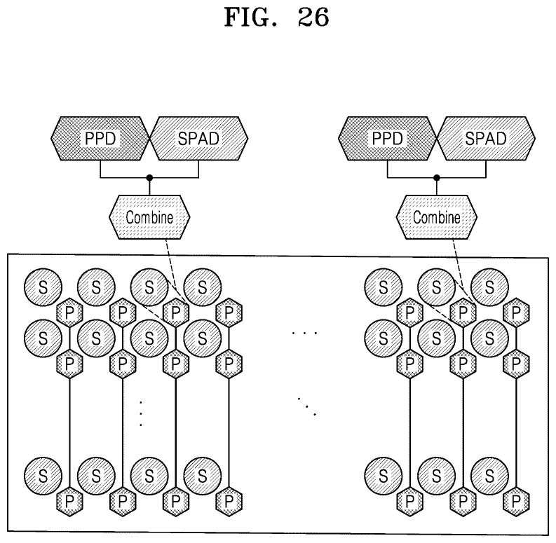

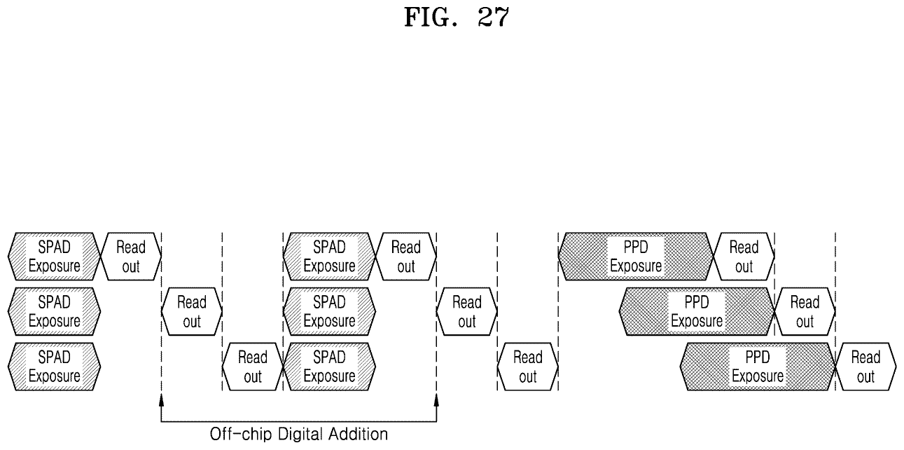

Referring to FIGS. 23 to 26, the pixel 300 of the image sensor may include an SPAD and a PPD as a hybrid pixel. In the current embodiment, the SPAD may be indicated by ‘S’ and the PPD may be indicated by ‘P’. FIG. 27 shows an example of a timing diagram of a pixel in an image sensor when both an APC mode and a CA mode of FIG. 26 are used.

Referring to FIG. 23, the pixel 300 may detect light by using the SPAD 312. In other words, in the APC mode described with reference to FIGS. 6 to 20, the light detected by the SPAD 312 may be used to count the number of photons in an analog manner through the analog detection unit 320. The image sensor including the pixel array may generate a frame image based on a result of counting the number of photons of each pixel.

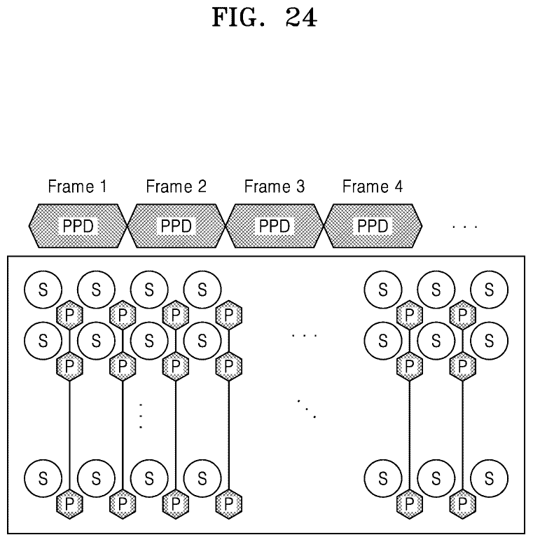

Referring to FIG. 24, the image sensor may detect light by using the PPD 322. In other words, in the CA mode described with reference to FIGS. 21 and 22, the number of photons may be counted through the analog detection unit 320.

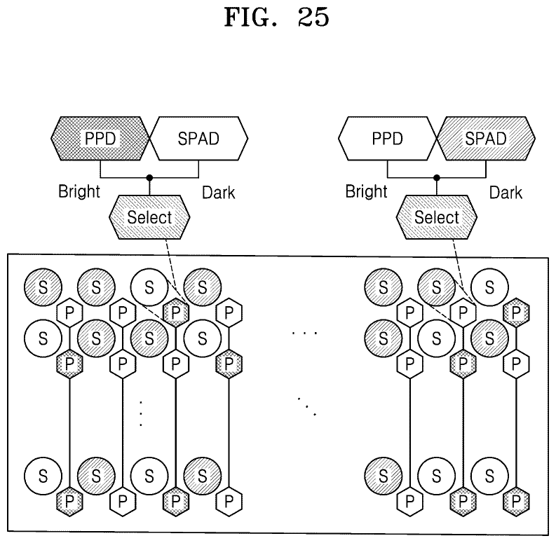

Referring to FIG. 25, the image sensor may adopt a different operating mode for each pixel 300. The intensity of light incident onto each pixel in the pixel array of the image sensor may be different. Thus, the image sensor may determine a mode in which each pixel operates, according to the intensity of light incident onto the pixel. For example, when the intensity of light incident onto a first pixel is less than a predefined value (i.e., in the low-illuminance situation), the image sensor may operate the first pixel in the APC mode. When the intensity of light incident onto the second pixel is greater than or equal to a specific value (i.e., in the high-illuminance situation), the image sensor may operate the second pixel in the CA mode. Thus, the image sensor may effectively implement HDR imaging by using a pixel operating in a different mode when the image sensor generates one frame image.

Referring to FIGS. 26 and 27, the image sensor may perform both the APC mode and the CA mode for each pixel. For example, the image sensor may operate the entire pixels of the pixel array in the APC mode to count the number of photons of each pixel, operate the entire pixel array in the CA mode to count the number of photons of each pixel, and sum a value of the APC mode and a value of the CA mode to output a summation result as a final result of each pixel.

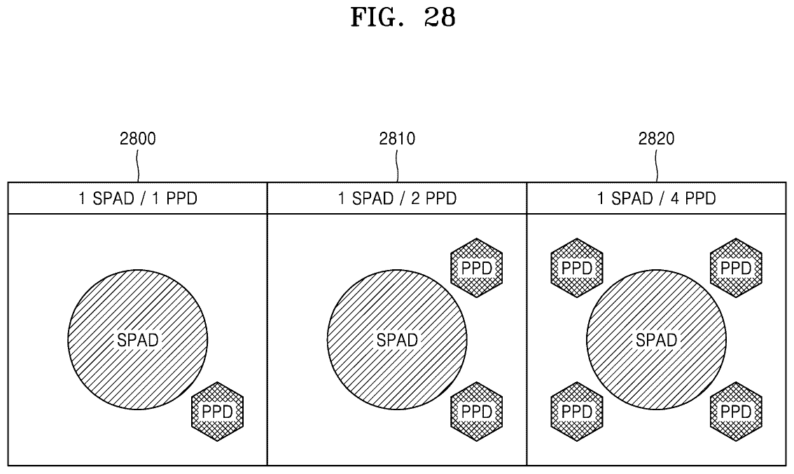

FIG. 28 shows an example of an arrangement structure of an SPAD and a PPD in a pixel of an image sensor according to an embodiment.

Referring to FIG. 28, as the size of the SPAD is greater than that of the PPD, a pixel of the image sensor may include one SPAD and a plurality of PPDs. For example, the image sensor may be implemented to include one SPAD and one PPD for each pixel as indicated by 2800 or to include one SPAD and two or more PPDs for each pixel as indicated by 2810 and 2820.

For example, in the example of FIG. 3, a plurality of analog detection units 320 may be connected in parallel to one digital detection unit 310. The digital detection unit 310 may alternately output electric charges to the plurality of analog detection units 320 upon detection of light by the SPAD 312.

When the photons are detected by using the SPAD in the APC mode, a time to transfer the electric charges accumulated in the PPD to the storage unit is quite long, making it impossible to detect the light incident onto the SPAD during electric charge transfer. However, by disposing a plurality of PPDs on one SPAD, as indicated by 2810 and 2820, as in the current embodiment, during electric charge transfer in any one PPD, the photons may be detected in another PPD. That is, photon pileup may be reduced.

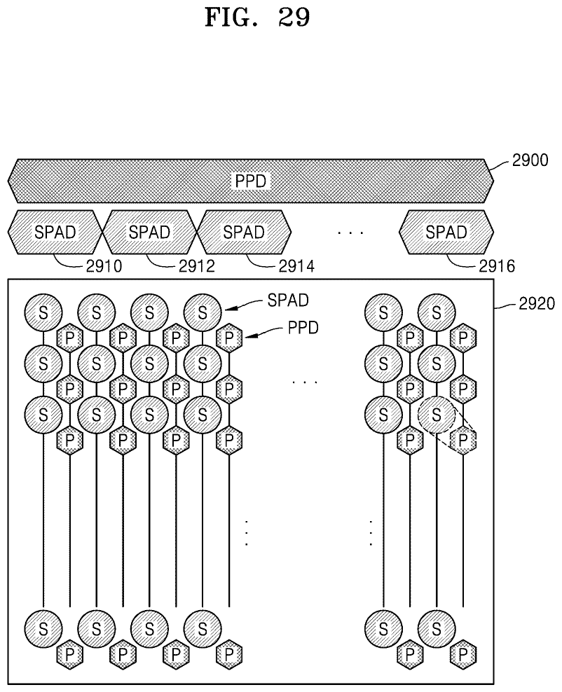

FIG. 29 shows another example of an image sensor according to an embodiment.

Referring to FIG. 29, a pixel 2920 of the image sensor may further include a readout path for an SPAD 2916. In the above-described pixel 300 of the image sensor, a readout path exists in the PPD, such that PPD imaging 2900 may be continuously performed, but for SPAD imaging 2910, 2912, 2915, and 2916, data has to be output via the PPD at all times.

However, when a readout path exists also in the SPAD as in the current embodiment, a light detection result of the SPAD may be read without passing through the PPD. Thus, the image sensor may separately operate the digital detection unit 310 and the analog detection unit 320 of the pixel 2920, thereby an operating mode of FIGS. 25 and 26 at a higher frame rate.

The disclosure may also be implemented as a computer-readable program code on a computer-readable recording medium. The computer-readable recording medium may include all types of recording devices in which data that is readable by a computer system is stored. Examples of the computer-readable recording medium may include read-only memory (ROM), random access memory (RAM), compact-disc ROM (CD-ROM), a magnetic tape, a floppy disk, an optical data storage device, etc. The computer-readable recording medium may be distributed over computer systems connected through a network to store and execute a computer-readable code in a distributed manner.

So far, embodiments have been described for the disclosure. It would be understood by those of ordinary skill in the art that the disclosure may be implemented in a modified form within a scope without departing from the essential characteristics of the disclosure. Therefore, the disclosed embodiments should be considered in a descriptive sense rather than a restrictive sense. The scope of the present specification is not described above, but in the claims, and all the differences in a range equivalent thereto should be interpreted as being included in the disclosure.

According to an embodiment, by implementing a hybrid pixel including a both SPAD and a PPD, an HDR may be implemented both in high illuminance and low illuminance conditions. Moreover, the number of photons detected in the SPAD may be counted using an analog counter of the PPD, thereby implementing the image sensor capable of accurately counting the photons in low illuminance conditions, in a small area.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An image sensor comprising:
a digital detection unit configured to detect light based on a single photon avalanche diode (SPAD);
an analog detection unit configured to detect light based on a pinned photodiode (PPD); and
a connection unit configured to transfer a specific amount of electric charges to the analog detection unit in detection of the light by the digital detection unit,
wherein the analog detection unit is further configured to count a number of photons based on an amount of electric charges accumulated during a specific time.

2. The image sensor of claim 1, wherein the SPAD and the PPD are arranged in one pixel.

3. The image sensor of claim 1, wherein the connection unit comprises:
a first gate unit configured to adjust a first gate potential between the digital detection unit and the analog detection unit; and
a second gate unit configured to adjust a second gate potential between the analog detection unit and a storage unit storing electric charges.

4. The image sensor of claim 3, wherein the storage unit comprises a capacitor connected in parallel to the analog detection unit to expand a full well capacity (FWC) where electric charges are accumulated in the analog detection unit.

5. The image sensor of claim 1, wherein the digital detection unit comprises a masking unit configured to determine whether to operate the SPAD according to a control signal.

6. The image sensor of claim 1, further comprising:
a first resetting unit configured to reset the digital detection unit; and
a second resetting unit configured to reset the analog detection unit.

7. The image sensor of claim 1, further comprising:
a plurality of analog detection units; and
a plurality of connection units,
wherein the digital detection unit is connected in parallel to the plurality of analog detection units through the plurality of connection units.

8. The image sensor of claim 1, further comprising a readout path configured to output light detection data of the digital detection unit.

9. A control method of an image sensor comprising a hybrid pixel comprising a single photon avalanche diode (SPAD) and a pinned photodiode (PPD), the control method comprising:
adjusting an electric potential of a first gate unit positioned between the SPAD and the PPD to isolate a specific amount of electric charges when electric charges are accumulated between the SPAD and the PPD upon incidence of photons onto the SPAD;
adjusting an electric potential of a second gate unit positioned between the PPD and the storage unit to transfer the specific amount of electric charges to the storage unit; and
counting a number of photons based on electric charges above a specific level in the storage unit.

10. The control method of claim 9, wherein the adjusting of the electric potential of the first gate unit comprises:
subtracting an amount of electric charges by predefined fixel pattern noise (FPN) from the amount of electric charges accumulated between the SPAD and the PPD; and
separating a specific amount of electric charges from the remaining amount of electric charges after the subtracting.

11. The control method of claim 9, further comprising:
identifying an intensity of light; and
selecting an analog photon counting (APC) mode to detect light based on the SPAD or a charge accumulation (CA) mode to detect light based on the PPD, according to the intensity of light.
